(19) United States
(12) Patent Application Publication
(10) Pub. No.: US 2019/0020700 A1
(43) Pub. Date: Jan. 17, 2019

(54) Transport of Legacy Transport Streams Over ABR Networks

(71) Applicant: Cisco Technology, Inc., San Jose, CA (US)

(72) Inventors: Henk Derudder, Ieper (BE); Samie Beheydt, Geluwe (BE); Jan Armand Josefine De Smet, Lokeren (BE); Frank Van de Vyver, Lokeren (BE)

(73) Assignee: Cisco Technology, Inc., San Jose, CA (US)

(21) Appl. No.: 15/649,753

(22) Filed: Jul. 14, 2017

(51) Int. Cl. H04L 29/06; H04N 21/2662; H04N 21/462; H04N 21/236; H04N 21/2381; H04N 21/2385

(52) U.S. Cl. CPC H04L 65/4076; H04N 21/2662; H04L 65/605; H04N 21/2385; H04N 21/236; H04N 21/2381; H04N 21/4621

(57) ABSTRACT

Transport of legacy transport streams over ABR networks may be provided. First, an operation mode comprising a transparent mode may be selected for a packager. Next, the packager may receive a transport stream and create data chunks from the transport stream using the transparent mode. Creating the data chunks from the transport stream using the transparent mode may comprise copying data packets from the transport stream into the data chunks and setting boundaries between the data chunks. The boundaries may be signaled by Encoder Boundary Points (EBP) from at least one packet identifier (PID) in the transport stream. Then the packager may send the data chunks.

### TECHNICAL FIELD

The present disclosure relates generally to data stream transportation.

### BACKGROUND

Adaptive bitrate (ABR) streaming is a method of video streaming over Hypertext Transfer Protocol (HTTP) where the source content is encoded at multiple bit rates, then each of the different bit rate streams are segmented into small multi-second or sub-second parts. The streaming client is made aware of the available streams at differing bit rates, and segments of the streams by a manifest file. When starting, the client typically requests the segments from the lowest bit rate stream. If the client finds the download speed is greater than the bit rate of the segment downloaded, then it may request the next higher bit rate segments. Later, if the client finds the download speed for a segment is lower than the bit rate for the segment, and therefore the network throughput has deteriorated, then it may request a lower bit rate segment. The segment size can vary depending on the particular implementation, but they are typically between two and ten seconds.

### BRIEF DESCRIPTION OF THE FIGURES

The accompanying drawings, which are incorporated in and constitute a part of this disclosure, illustrate various embodiments of the present disclosure. In the drawings:

FIG. 1 is a block diagram of an operating environment for providing transport of legacy transport streams over ABR networks;

FIG. 2 illustrates ABR streaming;

FIG. 3 illustrates ABR mode data chunks;

FIG. 4 is a flow chart of a method for providing transport of legacy transport streams over ABR networks;

FIG. 5 illustrates transparent mode data chunks; and

FIG. 6 is a block diagram of a computing device.

### DETAILED DESCRIPTION

### Overview

Transport of legacy transport streams over ABR networks may be provided. First, an operation mode comprising a transparent mode may be selected for a packager. Next, the packager may receive a transport stream and create data chunks from the transport stream using the transparent mode. Creating the data chunks from the transport stream using the transparent mode may comprise copying data packets from the transport stream into the data chunks and setting boundaries between the data chunks. The boundaries may be signaled by Encoder Boundary Points (EBP) from at least one packet identifier (PID) in the transport stream. Then the packager may send the data chunks.

Both the foregoing overview and the following example embodiments are examples and explanatory only, and should not be considered to restrict the disclosure's scope, as described and claimed. Further, features and/or variations may be provided in addition to those set forth herein. For example, embodiments of the disclosure may be directed to various feature combinations and sub-combinations described in the example embodiments.

### Example Embodiments

The following detailed description refers to the accompanying drawings. Wherever possible, the same reference numbers are used in the drawings and the following description to refer to the same or similar elements. While embodiments of the disclosure may be described, modifications, adaptations, and other implementations are possible. For example, substitutions, additions, or modifications may be made to the elements illustrated in the drawings, and the methods described herein may be modified by substituting, reordering, or adding stages to the disclosed methods. Accordingly, the following detailed description does not limit the disclosure. Instead, the proper scope of the disclosure is defined by the appended claims.

Service providers may provide both legacy first screen video/audio services and ABR (Adaptive Bit-Rate) services to subscribers. Currently, first screen services and ABR services may be handled in two distinct ways using, for example, separate workflows (e.g., ad insertion may be handled differently for first screen and ABR) and networks (e.g., legacy streaming video networks versus CDN for ABR). Services may be moved to a single workflow using one single infrastructure, which may comprise an ABR type infrastructure. Moving legacy transport stream based applications to an ABR workflow may be provided by embodiments of the disclosure. For example, embodiments of the disclosure may provide a way to support transport of legacy transport streams over Transmission Control Protocol (TCP) based networks using ABR delivery techniques in order to benefit from the CDN infrastructure as a transport/delivery infrastructure.

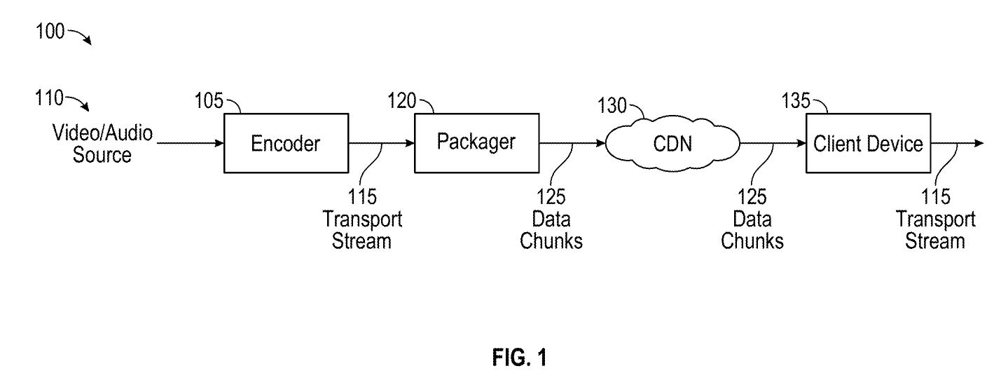

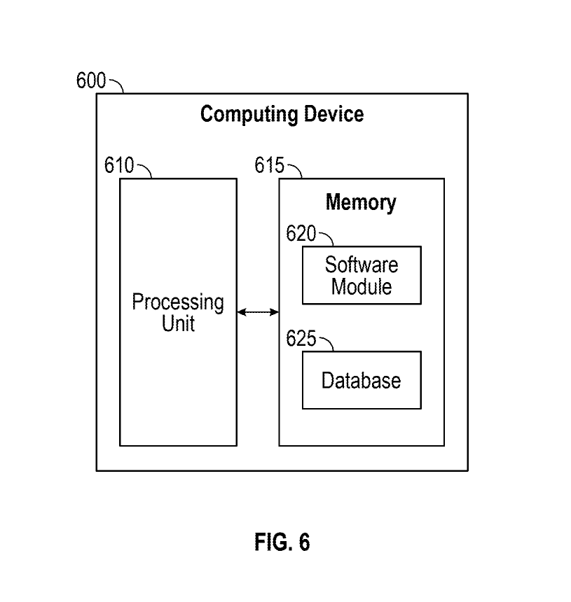

FIG. 1 is a block diagram of an operating environment 100 for providing transport of legacy transport streams over ABR networks. As shown in FIG. 1, operating environment 100 may comprise an encoder 105, a transport stream 115, a packager 120, data chunks 125, a content delivery network CDN 130, and a client device 135. Encoder 105, packager 120, or client device 135 may be embodied by computing device 600 described in greater detail below with respect to FIG. 6. Notwithstanding, encoder 105, packager 120, or client device 135 may be embodied in hardware and/or in software (including firmware, resident software, micro-code, etc.). Client device 135 may comprise, but is not limited to, a cellular base station, a tablet device, a mobile device, a smartphone, a telephone, a remote control device, a set-top box, a digital video recorder, a cable modem, a personal computer, a network computer, a mainframe, a router, or other similar microcomputer-based device. CDN 130 may comprise a collection of web servers and network components for example.

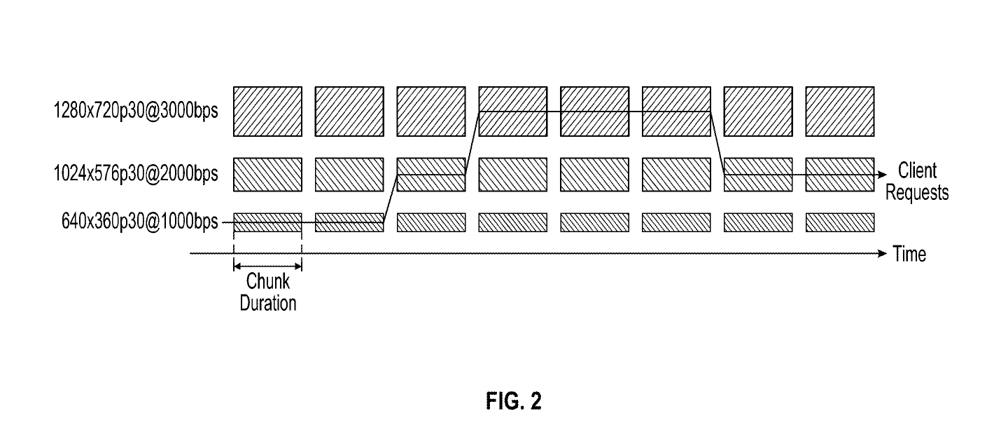

ABR video, audio, and metadata may be packaged in small media files (e.g., chunks) that may typically have a fixed duration (e.g., 2 s). Each ABR chunk may be fully decodable on its own (i.e., it may not need previous chunks for decoding). Audio and video that may be contained in an ABR chunk may be aligned (i.e., a first audio sample in the chunk may correspond to a first video sample in the chunk). With ABR, a single video/audio source may be encoded in multiple representations that may have different resolutions, framerates, and/or bitrates. Each of these representations may be separated into individually decodable chunks. Moreover, the chunk boundaries may be aligned (i.e., the corresponding chunks of the individual representations may start with the same video frame/audio sample). Aligning the chunk boundaries may allow an ABR client to seamlessly switch between the available representations at the chunk boundaries. This may allow the ABR client to switch to an appropriate representation based on the network bandwidth it has available at a certain moment of time. When the ABR client has a high network bandwidth available, it may switch to a representation that may have a higher video resolution, framerate, and bitrate. When the available bandwidth is lower, the ABR client may switch to a representation with a lower video resolution, framerate, and bitrate. This may be illustrated in FIG. 2.

As shown in FIG. 2, the ABR client may start requesting chunks for the lowest representation and then gradually increase the representation resolution and framerate. Towards the end, as shown in FIG. 2, the ABR client may request the middle representation, for example, because of network congestion. Regardless, in order for the ABR client to seamless switch, the chunks of the individual representations may need to be video frame aligned (and within a chunk, audio may be aligned with video). In an ABR mode, services may be encoded by encoder 105, packaged (i.e., cut in data chunks 125) by packager 120, and delivered to client device 135 over CDN 130. In the ABR mode, encoder 105 may encode the video/audio source to the video/audio format that may be needed (e.g., H.264 video and AAC audio) and may generate a set of representations of the ABR service (e.g., different resolutions, framerates and bitrates). In this mode, encoder 105 may also determine the chunk size and chunk alignment by inserting Encoder Boundary Points (EBPs) into transport stream 115. These EBPs may be inserted, for example, at regular intervals (e.g., 2 s) on the video Packet Identifier (PID) (alternatives are possible depending on the ABR format).

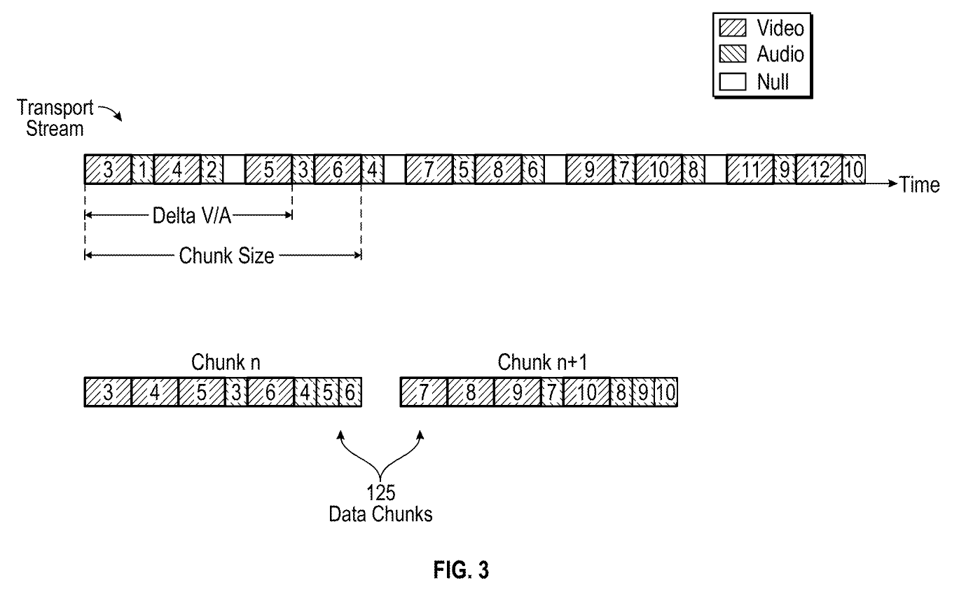

As illustrated in FIG. 3, in the ABR mode, packager 120 may read the EBPs and may create data chunks 125 that may align with these EBP boundaries. In order to create data chunks 125, packager 120 may remove transport stream null packets from transport stream 115. In other words, packager 120 may cut transport stream 115 based on the video EBPs. The packager may then manipulate the audio packets to compensate for the difference in video and audio decoding delay (e.g., the video packets may be sent earlier in time than corresponding audio packets). The first audio frame in data chunks 125 may be the one that corresponds with the first video frame in data chunks 125, the last audio frame in data chunks 125 may be the one that corresponds with the last video frame in data chunks 125 as illustrated in FIG. 3. This kind of manipulation may not only apply to audio, but may also apply to timestamped metadata (e.g., teletext, subtitles, etc.) that may be part of transport stream 115.

As shown in FIG. 3, the null portions illustrate transport stream null packets, the audio portions illustrate transport stream packets that may contain audio, and the video portions illustrate transport stream packets that may contain video. Delta V/A may represent the difference in decoding delay of video and audio that may cause video to be sent earlier in time than the corresponding audio. When creating data chunks 125 in the ABR mode, the audio may be aligned with the video that may result in multiple consecutive audio packets added at the end of data chunks 125. In the ABR mode, packager 120 may remove transport stream packets that may not be needed for the ABR format (e.g., Program Specific Information (PSI)/SI tables) and may add a single Program Association Table (PAT) and Program Map Table (PMT) section at the start of each of data chunks 125.

Because of the aforementioned manipulations, the resulting data chunks 125 may still be based on the transport stream packets, but transport stream 115 contained in data chunks 125 may no longer be standard compliant since the Program Clock Reference (PCR) and the decoder buffer models of video, audio, and timestamped metadata may no longer be correct. Another issue with packager 120 in the ABR mode may be that in order to be able to align the audio and timestamped metadata, it may need access to the Presentation Timestamp (PTS)/Decode Time Stamp (DTS) fields of the transport stream packets. However, they may not be available if transport stream based encryption (e.g., Digital Video Broadcast (DVB) Common Scrambling Algorithm (CSA)) has been applied to transport stream 115. Moreover, ABR mode delivery may be limited to single service delivery (i.e., the transport stream may be a Single Program Transport Stream (SPTS), one SPTS for each representation) because the ABR mode may require chunk alignment over the different representations.

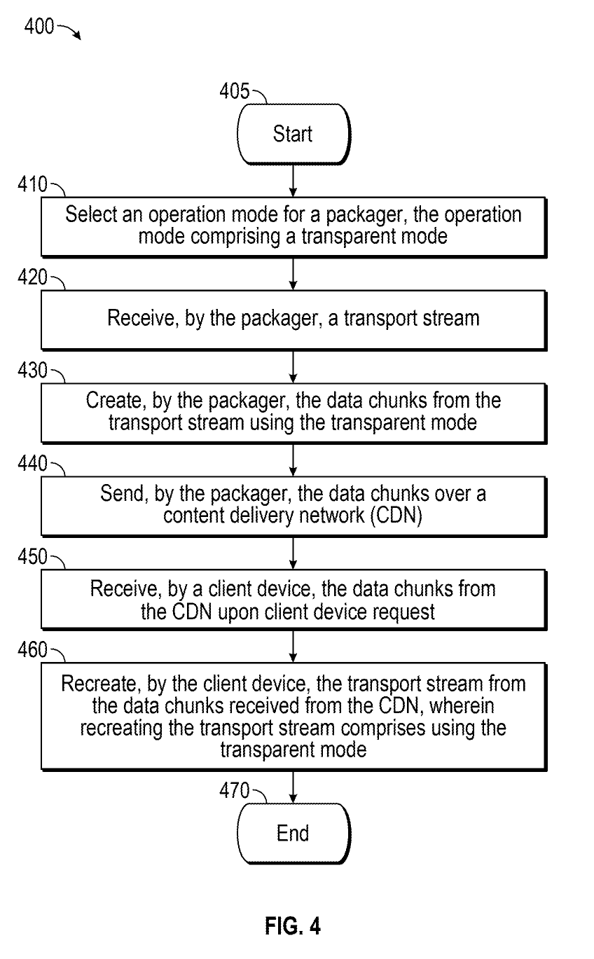

FIG. 4 is a flow chart setting forth the general stages involved in a method 400 consistent with an embodiment of the disclosure for providing transport of legacy transport streams over ABR networks. Method 400 may be implemented using operating environment 100 for providing transport of legacy transport streams over ABR networks as described above. Ways to implement the stages of method 400 will be described in greater detail below.

Method 400 may begin at starting block 405 and proceed to stage 410 where an operator may select an operation mode for packager 120. The selected operation mode may comprise, for example, a transparent mode. For example, an operator may decide which operation mode for packager 120 to operate within. While the operator may decide between the transparent mode and the ABR mode, the operation mode may comprise other operation modes and is not limited to the transparent mode or the ABR mode.

From stage 410, where the operator selects the operation mode for packager 120, method 400 may advance to stage 420 where packager 120 may receive transport stream 115. For example, packager 120 may receive transport stream 115 from encoder 105. Once packager 120 receives transport stream 115 in stage 420, method 400 may continue to stage 430 where packager 120 may create data chunks 125 from transport stream 115 using the transparent mode. For example, in the transparent mode, whatever is included in transport stream 115 coming from encoder 105 may be included in data chunks 125 at the output of packager 120. In other words, transport stream packets in transport stream 115 may be copied transparently into data chunks 125.

For the signaling of the chunk boundaries for data chunks 125, a number of processes may be used consistent with embodiments of the disclosure. In the case where transport stream 115 may contain a single service (i.e., single program), chunk boundaries for data chunks 125 may be signaled by EBPs on the video PID. Furthermore, in the case where transport stream 115 may contain multiple services, chunk boundaries for data chunks 125 may be signaled by EBPs on one of the video PIDs or multiple video PIDs can contain EBPs and packager 120 may select one of them. Even without EBPs in transport stream 115, packager 120 may decide where to insert chunk boundaries data chunks 125 (e.g., based on a fixed number of transport stream packets in a chunk).

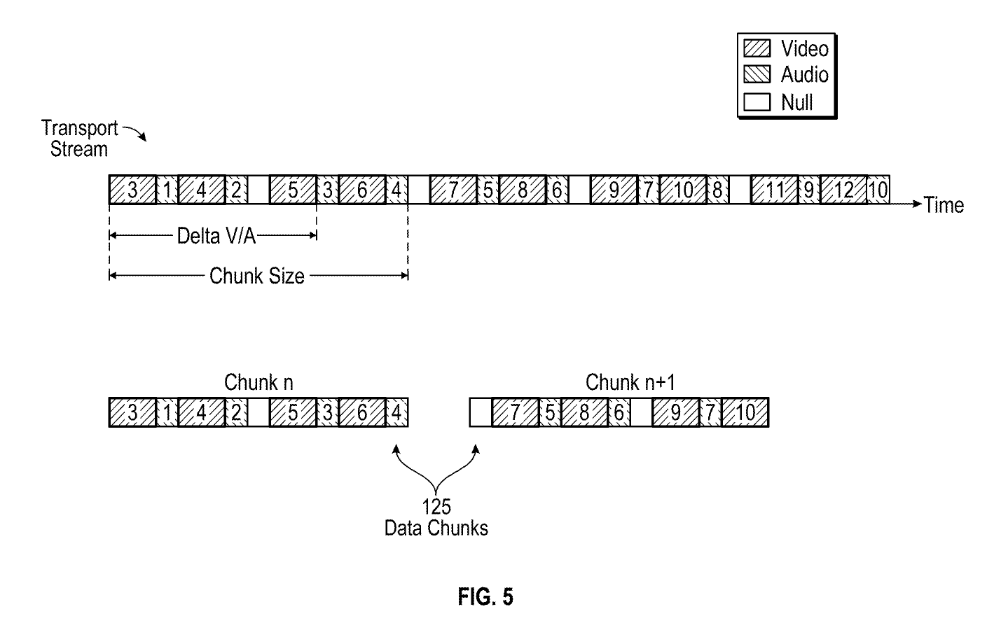

FIG. 5 shows an example of data chunks 125 for transport stream 115 when packager 120 is in the transparent mode. As shown in FIG. 5, packets from transport stream 115 may be copied into data chunks 125. The difference in decoding latency of video relative to audio (DeltaV/A) may no longer be of importance because, in the transparent mode, the transport stream packets may be handled the same.

After packager 120 creates data chunks 125 from transport stream 115 in stage 430, method 400 may proceed to stage 440 where packager 120 may send data chunks 125 over CDN 130. From stage 440, where packager 120 sends data chunks 125 over CDN 130 upon client device 135 request, method 400 may advance to stage 450 where client device 135 may receive data chunks 125 from CDN 130. For example, data chunks 125 may be delivered to CDN 130, which may comprise a collection of web servers and network components. Client device 135 may request data chunks 125 from the CDN 130, for example, via standard HTTP calls.

Once client device 135 receives data chunks 125 from CDN 130 in stage 450, method 400 may continue to stage 460 where client device 135 may recreate transport stream 115 from data chunks 125 received from CDN 130. Recreating transport stream 115 may comprise using the transparent mode. For example, client device 135 may request the transparent mode packaged data chunks 125 from CDN 130 and reconstruct transport stream 115, for example, in a bit-by-bit identical way. This may be done by concatenating the requested data chunks 125 and sending this concatenation as one fully compliant transport stream (i.e., transport stream 115). Once client device 135 recreates transport stream 115 from data chunks 125 received from CDN 130 in stage 460, method 400 may then end at stage 470.

Consistent with embodiments of the disclosure, client device 135 in the transparent mode may have a different purpose than client device 135 in the ABR mode. For example, client device 135 in the ABR mode may requests ABR video chunks based on varying network conditions in order to render a seamless video/audio experience at its output. However, client device 135 in the transparent mode may request packaged chunks from CDN 130 and reconstruct the original transport stream 115, for example, in a bit-by-bit identical way. This may be done by concatenating the requested data chunks and sending them out as one compliant transport stream, for example, wrapped into a continuous UDP stream as described in, but not limited to, SMPTE 2022-2. In the transparent mode, client device 135 may have one representation available to request.

Transparent mode packaging in combination with a transparent mode client device may have the following benefits over ABR mode for transport of legacy transport streams over an ABR network. First, while the ABR mode may support single-program transport streams, transparent mode packaging may support both single-program transport streams and multi-program transport streams. In addition, because the transparent mode may not need to inspect the content of the transport stream packets to do its packaging, the transparent mode may operate on transport streams that have been encrypted on the transport stream layer (e.g., DVB-CSA encryption) for example. Furthermore, because packager 120 may be agnostic to the incoming transport stream (e.g., it may transparently copy incoming transport stream packets to data chunks 125) packager 120, in the transparent mode, may be used to transport any incoming transport stream. Moreover, because of transparent mode packaging and the way the transparent mode client devices work, the output of client device 135 in the transparent mode may be bit-by-bit identical to the original transport stream coming out of encoder 105. This may be an important feature for applications where transport stream packet timing is of importance and where the transport stream packet order cannot be changed.

FIG. 6 shows computing device 600. As shown in FIG. 6, computing device 600 may include a processing unit 610 and a memory unit 615. Memory unit 615 may include a software module 620 and a database 625. While executing on processing unit 610, software module 620 may perform processes for providing transport of legacy transport streams over ABR networks, including for example, any one or more of the stages from method 400 described above with respect to FIG. 4. Computing device 600 may provide an operating environment for any one of more of encoder 105, packager 120, and client device 135. Encoder 105, packager 120, and client device 135 may operate in other environments and are not limited to computing device 600.

Computing device 600 may be implemented using a Wi-Fi access point, a cellular base station, a tablet device, a mobile device, a smart phone, a telephone, a remote control device, a set-top box, a digital video recorder, a cable modem, a personal computer, a network computer, a mainframe, a router, a camera, a load balancer or other similar microcomputer-based device. Computing device 600 may comprise any computer operating environment, such as hand-held devices, multiprocessor systems, microprocessor-based or programmable sender electronic devices, minicomputers, mainframe computers, and the like. Computing device 600 may also be practiced in distributed computing environments where tasks are performed by remote processing devices. The aforementioned systems and devices are examples and computing device 600 may comprise other systems or devices.

Embodiments of the disclosure, for example, may be implemented as a computer process (method), a computing system, or as an article of manufacture, such as a computer program product or computer readable media. The computer program product may be a computer storage media readable by a computer system and encoding a computer program of instructions for executing a computer process. The computer program product may also be a propagated signal on a carrier readable by a computing system and encoding a computer program of instructions for executing a computer process. Accordingly, the present disclosure may be embodied in hardware and/or in software (including firmware, resident software, micro-code, etc.). In other words, embodiments of the present disclosure may take the form of a computer program product on a computer-usable or computer-readable storage medium having computer-usable or computer-readable program code embodied in the medium for use by or in connection with an instruction execution system. A computer-usable or computer-readable medium may be any medium that can contain, store, communicate, propagate, or transport the program for use by or in connection with the instruction execution system, apparatus, or device.

The computer-usable or computer-readable medium may be, for example, but not limited to, an electronic, magnetic, optical, electromagnetic, infrared, or semiconductor system, apparatus, device, or propagation medium. More specific computer-readable medium examples (a non-exhaustive list), the computer-readable medium may include the following: an electrical connection having one or more wires, a portable computer diskette, a random access memory (RAM), a read-only memory (ROM), an erasable programmable read-only memory (EPROM or Flash memory), an optical fiber, and a portable compact disc read-only memory (CD-ROM). Note that the computer-usable or computer-readable medium could even be paper or another suitable medium upon which the program is printed, as the program can be electronically captured, via, for instance, optical scanning of the paper or other medium, then compiled, interpreted, or otherwise processed in a suitable manner, if necessary, and then stored in a computer memory.

While certain embodiments of the disclosure have been described, other embodiments may exist. Furthermore, although embodiments of the present disclosure have been described as being associated with data stored in memory and other storage mediums, data can also be stored on or read from other types of computer-readable media, such as secondary storage devices, like hard disks, floppy disks, or a CD-ROM, a carrier wave from the Internet, or other forms of RAM or ROM. Moreover, the semantic data consistent with embodiments of the disclosure may be analyzed without being stored. In this case, in-line data mining techniques may be used as data traffic passes through, for example, a caching server or network router. Further, the disclosed methods' stages may be modified in any manner, including by reordering stages and/or inserting or deleting stages, without departing from the disclosure.

Furthermore, embodiments of the disclosure may be practiced in an electrical circuit comprising discrete electronic elements, packaged or integrated electronic chips containing logic gates, a circuit utilizing a microprocessor, or on a single chip containing electronic elements or microprocessors. Embodiments of the disclosure may also be practiced using other technologies capable of performing logical operations such as, for example, AND, OR, and NOT, including but not limited to, mechanical, optical, fluidic, and quantum technologies. In addition, embodiments of the disclosure may be practiced within a general purpose computer or in any other circuits or systems.

Embodiments of the disclosure may be practiced via a system-on-a-chip (SOC) where each or many of the components illustrated in FIG. 1 may be integrated onto a single integrated circuit. Such an SOC device may include one or more processing units, graphics units, communications units, system virtualization units and various application functionality of which may be integrated (or “burned”) onto the chip substrate as a single integrated circuit. When operating via an SOC, the functionality described herein with respect to embodiments of the disclosure, may be performed via application-specific logic integrated with other components of computing device 600 on the single integrated circuit (chip).

Embodiments of the present disclosure, for example, are described above with reference to block diagrams and/or operational illustrations of methods, systems, and computer program products according to embodiments of the disclosure. The functions/acts noted in the blocks may occur out of the order as shown in any flowchart. For example, two blocks shown in succession may in fact be executed substantially concurrently or the blocks may sometimes be executed in the reverse order, depending upon the functionality/acts involved.

While the specification includes examples, the disclosure's scope is indicated by the following claims. Furthermore, while the specification has been described in language specific to structural features and/or methodological acts, the claims are not limited to the features or acts described above. Rather, the specific features and acts described above are disclosed as example for embodiments of the disclosure.

1. A method comprising:
selecting, for a packager, an operation mode from a plurality of operation modes comprising a transparent mode and an adaptive bit-rate (ABR) mode, wherein selecting the operation mode comprises selecting the transparent mode;
receiving, by the packager, a transport stream;
creating, by the packager, data chunks from the transport stream using the transparent mode, wherein creating the data chunks from the transport stream using the transparent mode comprises:
copying all data packets that are included in the transport stream into the data chunks, and
setting boundaries between the data chunks, the boundaries being signaled by Encoder Boundary Points (EBP) from at least one packet identifier (PID) in the transport stream; and
sending, by the packager, the data chunks.

2. (canceled)

3. The method of claim 1, wherein receiving the transport stream comprises receiving the transport stream from an encoder.

4. The method of claim 1, wherein sending the data chunks comprises sending the data chunks over a content delivery network (CDN).

5. The method of claim 1, wherein sending, by the packager, the data chunks comprises sending the data chunks to a client device.

6. The method of claim 5, further comprising causing the client device to operate in the transparent mode.

7. The method of claim 1, further comprising:
receiving, by a client device, the data chunks from a CDN; and
recreating, by the client device, the transport stream from the data chunks received from the CDN, wherein recreating the transport stream comprises using the transparent mode.

8. The method of claim 7, wherein recreating the transport stream using the transparent mode comprises concatenating the data chunks received from the CDN.

9. A system comprising:
a memory storage; and
a processing unit coupled to the memory storage, wherein the processing unit is operative to:
receive a transport stream;
select an operation mode for a packager from a plurality of operation modes comprising a transparent mode and an adaptive bit-rate (ABR) mode, wherein selecting the operation mode comprises selecting the transparent mode;
create data chunks from the transport stream using the transparent mode wherein the processing unit being operative to create the data chunks from the transport stream using the transparent mode comprises the processing unit being operative to;
copy all data packets that are included in the transport stream into the data chunks, and
set boundaries between the data chunks, the boundaries being signaled by Encoder Boundary Points (EBP) from at least one packet identifier (PID) in the transport stream; and
send the data chunks.

10. (canceled)

11. The system of claim 9, wherein the processing unit being operative to receive the transport stream comprises the processing unit being operative to receive the transport stream from an encoder.

12. The system of claim 9, wherein the processing unit being operative to send the data chunks comprises the processing unit being operative to send the data chunks over a content delivery system (CDN).

13. The system of claim 9, wherein the processing unit being operative to send the data chunks comprises the processing unit being operative to send the data chunks to a client device.

14. A method comprising:
selecting an operation mode for a packager from a plurality of operation modes comprising a transparent mode and an adaptive bit-rate (ABR) mode, wherein selecting the operation mode comprises selecting the transparent mode;
receiving, by the packager, a transport stream;
creating, by the packager, data chunks from the transport stream using the transparent mode, wherein creating the data chunks from the transport stream using the transparent mode comprises:
copying all data packets that is included in the transport stream into the data chunks, and
setting boundaries between the data chunks, the boundaries being signaled by Encoder Boundary Points (EBP) from at least one packet identifier (PID) in the transport stream;
sending, by the packager, the data chunks over a content delivery network (CDN);
receiving, by a client device, the data chunks from the CDN; and
recreating, by the client device, the transport stream from the data chunks received from the CDN, wherein recreating the transport stream comprises using the transparent mode.

15. (canceled)

16. The method of claim 14, wherein receiving the transport stream comprises receiving the transport stream from an encoder.

17. The method of claim 14, wherein setting the boundaries comprises:
setting boundaries between the data chunks based upon a predetermined number of transport stream data packets per data chunk.

18. (canceled)

19. The method of claim 14, wherein recreating the transport stream using the transparent mode comprises concatenating the data chunks received from the CDN.

20. The method of claim 14, further comprising causing the client device to operate in the transparent mode.
